(19) United States
(12) Patent Application Publication
(10) Pub. No.: US 2022/0207267 A1
(43) Pub. Date: Jun. 30, 2022

(54) COMPUTER-READABLE RECORDING MEDIUM STORING DETECTION PROGRAM, DETECTION METHOD, AND DETECTION DEVICE

(71) Applicant: FUJITSU LIMITED, Kawasaki-shi (JP)

(72) Inventors: Shinji Shigeno, Oita (JP); Kozo Baba, Oita (JP)

(73) Assignee: FUJITSU LIMITED, Kawasaki-shi (JP)

(21) Appl. No.: 17/478,357

(22) Filed: Sep. 17, 2021

(30) Foreign Application Priority Data
Dec. 25, 2020 (JP) 2020-218031

(51) Int. Cl. G06K 9/00; G08B 21/18; G08B 21/22; H04N 7/18; G06N 20/00

(52) U.S. Cl. CPC G06K 9/00362; G08B 21/182; G06N 20/00; H04N 7/185; G08B 21/22

(57) ABSTRACT

A non-transitory computer-readable recording medium stores a detection program for causing a computer to execute processing including, detecting a person included in a plurality of first captured images captured by a camera, determining a threshold value on the basis of a size in a height direction in the plurality of first captured images of the detected person, and detecting a target from the first captured image captured by the camera on the basis of the threshold value.

### CROSS-REFERENCE TO RELATED APPLICATION

This application is based upon and claims the benefit of priority of the prior Japanese Patent Application No. 2020-218031, filed on Dec. 25, 2020, the entire contents of which are incorporated herein by reference.

### FIELD

The embodiment discussed herein is related to a detection technique.

### BACKGROUND

There is a technique of having surveillance cameras installed in facilities and premises and detecting intrusion of people and vehicles using a video of the surveillance cameras.

Japanese Laid-open Patent Publication No. 2020-113964, Japanese Laid-open Patent Publication No. 2013-042386, and Japanese Laid-open Patent Publication No. 2002-373388 are disclosed as related art.

### SUMMARY

According to an aspect of the embodiments, a non-transitory computer-readable recording medium stores a detection program for causing a computer to execute processing including, detecting a person included in a plurality of first captured images captured by a camera, determining a threshold value on the basis of a size in a height direction in the plurality of first captured images of the detected person, and detecting a target from the first captured image captured by the camera on the basis of the threshold value.

The object and advantages of the invention will be realized and attained by means of the elements and combinations particularly pointed out in the claims

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a detection system;

FIG. 2 is a diagram illustrating a configuration example of a detection device;

FIG. 3 is a diagram illustrating an example of detecting a person for determining a detection size;

FIG. 4 is a diagram illustrating an example of a method of determining a detection size in a height direction of a person;

FIG. 5 is a diagram illustrating an example of a method of determining a detection size in a width direction of a person;

FIG. 6 is a diagram illustrating an example of a method of determining a detection size of a vehicle in the height direction;

FIG. 7 is a diagram illustrating an example of a method of determining a detection size of a vehicle in the width direction;

FIG. S is a flowchart illustrating a flow of detection size determination processing;

FIG. 9 is a flowchart illustrating a flow of detection processing; and

FIG. 10 is a diagram for describing a hardware configuration example.

### DESCRIPTION OF EMBODIMENTS

For example, in the case of installing the surveillance cameras in an unmanned facility, a vast site, or the like, constant surveillance by a person is a heavy load, and the number of cameras that can be monitored by one person is limited,

In one aspect, an objective is to provide a detection program, a detection method, and a detection device capable of assisting surveillance using a video of a surveillance camera.

Hereinafter, examples of a detection program, a detection method, and a detection device according to the present embodiment will be described in detail with reference to the drawings. Note that the present embodiment is not limited by the examples. Furthermore, examples can be appropriately combined within a range without inconsistency,

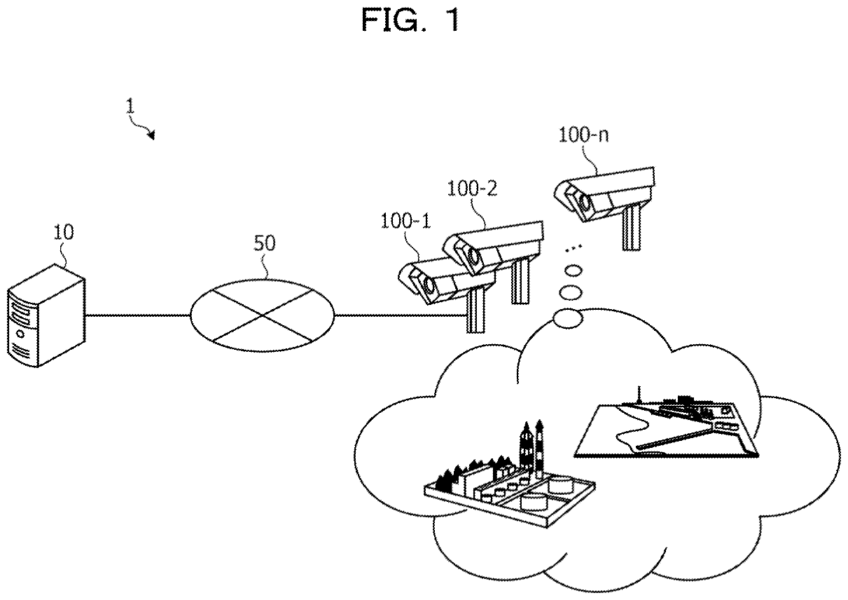

First, a detection system for implementing the present embodiment will be described. FIG. 1 is a diagram illustrating a configuration example of a detection system. As illustrated in FIG. 1, a detection system 1 is a system in which a detection device 10 and camera devices 100-1 to 100-n (n is an arbitrary integer, hereinafter collectively referred to as “camera device(s) 100”) are communicatively connected to one another via a network 50. Note that, as the network 50, various communication networks such as the Internet can be adopted regardless of wired or wireless communication.

The detection device 10 is, for example, an information processing device such as a desktop personal computer (PC) or a server computer used and managed by a surveillant who monitors a facility where the camera devices 100 are installed, and the like. The detection device 10 detects a person included in a surveillance video captured by the camera device 100, that is, in a plurality of captured images captured by the camera device 100, and determines threshold values on the basis of the size in the height direction in the captured image of the detected person. Then, the camera device 100 detects a target from the captured image captured by the camera device 100 on the basis of the determined threshold values.

Here, the target detected by the detection device 10 is, for example, a person or a vehicle. Furthermore, the threshold values determined by the detection device 10 are upper limits and lower limits of respective sizes in the height direction and a width direction for detecting a person and a vehicle. For example, when a person is detected from the video of the surveillance camera, rain marks on a road surface or snow on a tree branch included in the video may be erroneously detected as a small person. Therefore, the detection device 10 uses the threshold values for the size of a region detected as a person or a vehicle to determine whether to detect the region as the person or the vehicle.

The threshold values can change depending on the distance between the installed camera device 100 and a region where the person or vehicle to be captured passes and an imaging angle of the camera device 100, and may be set by calibration when the detection system 1 is constructed. Note that, by determining the threshold values of the sizes in the height direction and the width direction of a person and a vehicle from the size in the height direction of a person, parameter settings can be more easily performed than a case of detecting both of a person and a vehicle and determining the threshold values from the respective sizes in the height direction and the width direction.

Note that FIG. 1 illustrates the detection device 10 as one computer. However, the detection device 10 may be a distributed computing system configured by a plurality of computers. Alternatively, the detection device 10 may be a cloud server device managed by a service provider that provides a cloud computing service.

The camera device 100 is a so-called surveillance camera in ailed in an unmanned facility, a vast site, or the like. The camera device 100 transmits the captured surveillance video to the detection device 10 via the network 50.

[Functional Configuration of Detection Device 10]

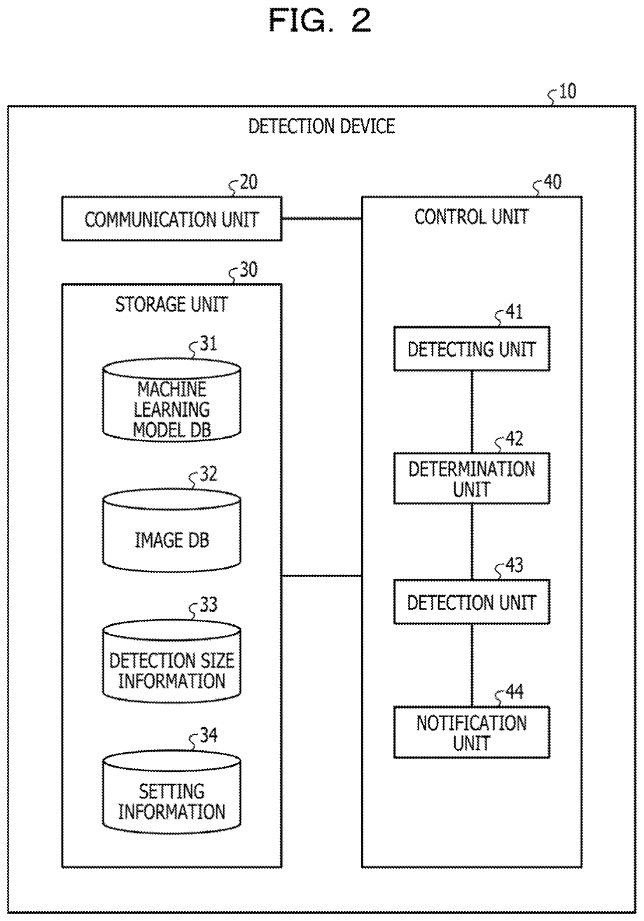

Next, a functional configuration of the detection device 10 illustrated in FIG. 1 will be described. FIG. 2 is a diagram illustrating a configuration example of a detection device. As illustrated in FIG. 2, the detection device 10 includes a communication unit 20, a storage unit 30, and a control unit 40.

The communication unit 20 is a processing unit that controls communication with other devices such as the camera device 100, and is, for example, a communication interface such as a network interface card.

The storage unit 30 is an example of a storage device that stores various data and a program executed by the control unit 40 and is, for example, a memory, a hard disk, or the like. The storage unit 30 stores a machine learning model DB 31, an image DB 32, a detection size information 33, setting information 34, and the like.

The machine learning model DB 31 stores, for example, parameters for constructing a machine learning model generated on the basis of training data including the captured image by the camera device 100 and a correct answer label indicating the target included in the captured image, and training data for the model.

The image DB 32 stores the captured image captured by the camera device 100. Furthermore, the image DB 32 can store the captured image in which a person or a vehicle is detected as a detection image in association with log information.

The detection size information 33 ores the upper limits and the lower limits of the respective sizes in the height and width directions for detecting a person and a vehicle, that is, the threshold values, as detection sizes. Note that the detection size information 33 may store only one of the upper limit or the lower limit of each size. Furthermore, the detection size information 33 may store a minimum value and a maximum value in the height direction of a person, which is the basis for calculating the threshold values.

The setting information 34 stores various types of setting information such as a range for detecting a person or a vehicle in an unmanned facility, a vast site, or the like, a target to be detected from a captured image, and a notification destination when a person or a vehicle is detected. Here, regarding the range for detecting a person or a vehicle, there are areas where surveillance is not needed in an unmanned facility, or the like. Therefore, for example, a detection range can be limited by designating in advance a range to be detected or a range not to be detected for the captured image. Furthermore, the target to be detected from the captured image is, for example, only a person, only a vehicle, or a person and a vehicle. Furthermore, the notification destination also includes a notification means, and the notification means are, for example, lighting a light source such as a patrol lamp, outputting a sound such as a voice or a notification sound, transmitting an e-mail to a predetermined e-mail address, and the like.

Note that the above-described information stored in the storage unit 30 is merely an example, and the storage unit 30 can store various types of information other than the above-described information.

The control unit 40 is a processing unit that controls the entire detection device 10 and is, for example, a processor or the like. The control unit 40 includes a detecting unit 41, a determination unit 42, a detection unit 43, and a notification unit 44. Note that each processing unit is an example of an electronic circuit included in a processor and an example of a process performed by the processor.

The detecting unit 41 detects a person or a vehicle included in the captured image captured by the camera device 100. The detection of a person or vehicle by the detecting unit 41 is performed using the machine learning model generated on the basis of the training data including the captured image and the correct answer label indicating the target included in the captured image. Furthermore, the target to be detected from the captured image can be designated as only a person, only a vehicle, or a person and a vehicle according to the setting information 34,

The determination unit 42 determines the threshold values on the basis of the size in the height direction of the captured image of the person detected by the detecting unit 41. The threshold values include, for example, the threshold value for the size in the height direction of a detection target and the threshold value for the size in the width direction of the detection target. More specifically, the determination unit 42 determines the upper limits and the lower limits for the sizes in the height direction and the width direction of a person or a vehicle to be detected on the basis of the minimum value and the maximum value of the size in the height direction in the captured image of the detected person.

The detection unit 43 detects the target from the captured image captured by the camera device 100 on the basis of the threshold values determined by the determination unit 42. More specifically, the detection unit 43 detects a person or a vehicle having a size within the range of the threshold values determined by the determination unit 42 from the captured image captured by the camera device 100. In other words, for example, even in the case where an arbitrary target is detected as a person or a vehicle from the captured image using the machine learning model, the detection unit 43 controls the process not to detect the target as a person or a vehicle in the case where the size falls outside the range of the threshold values determined by the determination unit 42,

Furthermore, the detection unit 43 can detect the arbitrary target as a person or a vehicle in the case where the target is detected from a predetermined number of captured images of a plurality of captured images captured in succession, for example, three or more frames of captured images out of ten frames of captured images so as not to erroneously detect noise included in the captured images. Furthermore, the detection unit 43 can detect a person or a vehicle from the range of the captured image preset by the setting information 34.

The notification unit 44 notifies the surveillant of detection of the person or vehicle in response to the detection of the person or vehicle by the detection unit 43 by, for example, turning on a light source such as a patrol lamp, outputting a sound such as a voice or a notification sound, transmitting an e-mail to a predetermined e-mail address, or the like.

[Function Details]

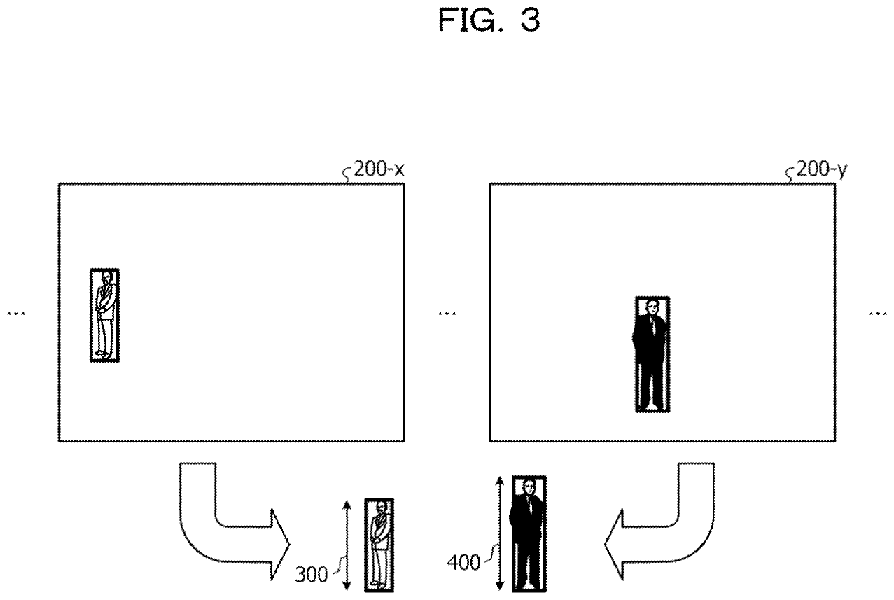

Next, a detection method according to the present embodiment will be described in detail with reference to FIGS. 3 to 7. FIG. 3 is a diagram illustrating an example of detecting a person for determining the detection size. As illustrated in FIG. 3, persons are placed at various positions to be monitored, and a captured image group including captured images 200-x and 200-y (where x and y are arbitrary integers) is captured by the camera device 100 (hereinafter, the captured image group will be collectively called “captured image(s) 200”). The captured image 200 is transmitted and input to the detection device 10, and the detection device 10 detects the person included in the captured image 200, using the machine learning model. Then, the detection device 10 acquires a minimum value 300 and a maximum value 400 of the size in the height direction in the captured image 200 of the detected person. Note that the size may be, for example, as illustrated in FIG. 3, the number of pixels in a vertical direction of a rectangle surrounding the detected person, a length calculated from the number of pixels, or the like.

In the present embodiment, the upper limits and the lower limits for the sizes in the height direction and the width direction of a person or a vehicle to be detected are determined as the detection sizes on the basis of the minimum value 300 and the maximum value 400 of the size in the height direction in the acquired person. Next, a method of determining each detection size will be described.

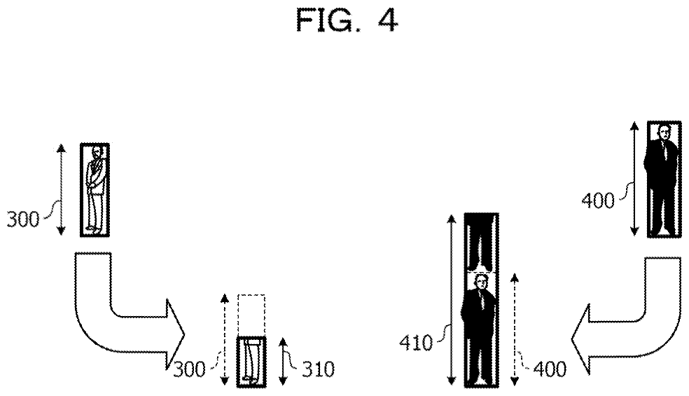

First, a method of determining the detection size in the height direction of a person will be described. FIG. 4 is a diagram illustrating an example of a method of determining a detection size in the height direction of a person. As illustrated in FIG. 4, the detection device 10 multiplies the minimum value 300 by 50%, for example, on the basis of the minimum value 300 of the size in the height direction of a person to calculate a lower limit 310 of the detection size in the height direction of a person. Similarly, the detection device 10 multiplies the maximum value 400 of the size in the height direction of a person by 150% to calculate an upper limit 410 of the detection size in the height direction of a person.

Note that the numerical values to be multiplied when calculating the lower limit 310 and the upper limit 410 are not limited to 50% and 150% and can be changed to any values. The detection device 10 uses the lower limit 310 and the upper limit 410 calculated as described above and controls the process not to detect the arbitrary target detected as a person from the captured image as a person in the case where the target has a size out of the range from the lower limit 310 to the upper limit 410 of the detection size in the height direction of a person.

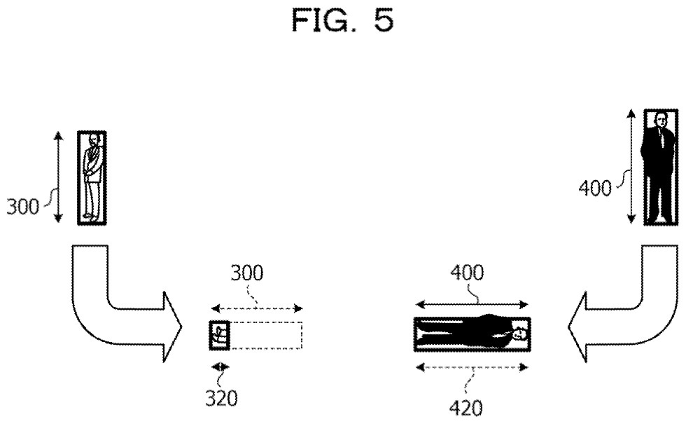

Next, a method of determining the detection size in the width direction of a person will be described. FIG. 5 is a diagram illustrating an example of the method of determining the detection size in the width direction of a person. As illustrated in FIG. 5, the detection device 10 multiplies the minimum value 300 by 20%, for example, on the basis of the minimum value 300 of the size in the height direction of a person to calculate a lower limit 320 of the detection size in the width direction of a person. Similarly, the detection device 10 multiplies the maximum value 400 of the size in the height direction of a person by 100% to calculate an upper limit 420 of the detection size in the width direction of a person.

Furthermore, the numerical values to be multiplied when calculating the lower limit 320 and the upper limit 420 are not limited to 20% and 100% and can be changed to any values, In this way, since the detection device 10 can determine the detection sizes in the height direction and the width direction of a person only by the size in the height direction of a person, the parameter settings can be more easily performed than the case of determining the threshold values from the respective minimum values and maximum values of the sizes in the height direction and the width direction of a person.

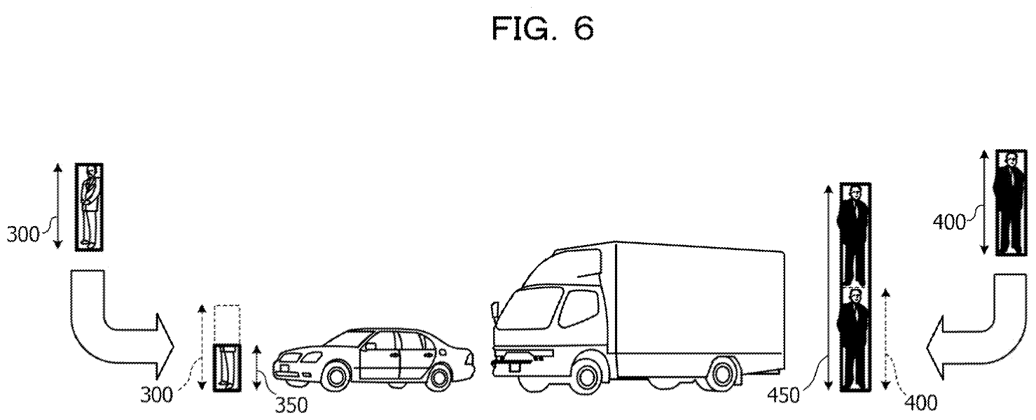

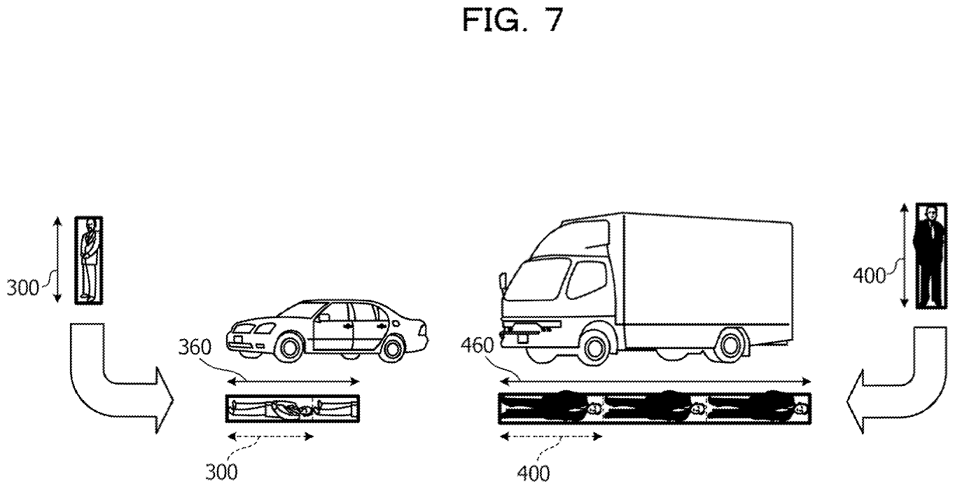

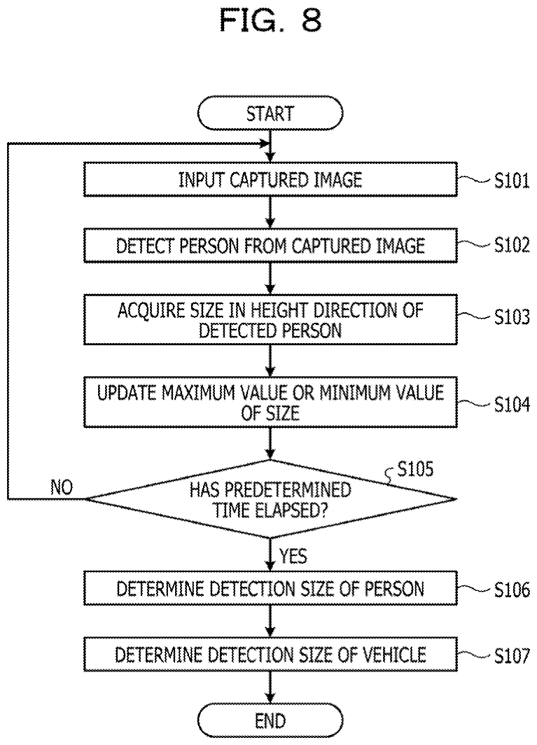

Next, a method of determining the detection size of a vehicle will be described. FIG. 6 is a diagram illustrating an example of the method of determining the detection size in the height direction of a vehicle. As illustrated in FIG. 6, the detection device 10 multiplies the minimum value 300 by 50%, for example, on the basis of the minimum value 300 of the size in the height direction of a person to calculate a lower limit 350 of the detection size in the height direction of a vehicle. Similarly, the detection device 10 multiplies the maximum value 400 of the size in the height direction of a person by 200% to calculate an upper limit 450 of the detection size in the height direction of a vehicle. Furthermore, FIG. 7 is a diagram illustrating an example of the method of determining the detection size in the width direction of a vehicle. As illustrated in FIG. 7, the detection device 10 multiplies the minimum value 300 by 150%, for example, on the basis of the minimum value 300 of the size in the height direction of a person to calculate a lower limit 360 of the detection size in the width direction of a vehicle. Similarly, the detection device 10 multiplies the maximum value 400 of the size in the height direction of a person by 300% to calculate an upper limit 460 of the detection size in the width direction of a vehicle.

Note that the numerical values to be multiplied with the minimum value 300 and the maximum value 400 are not limited to the above-described numerical values and can be changed to any values when calculating the detection size of a vehicle, In this way, since the detection device 10 can determine not only the detection sizes of a person but also the detection sizes of a vehicle only by the size in the height direction of a person, the detection device 10 can more easily perform the parameter settings than the case of determining the threshold values from the respective minimum values and maximum values of the sizes in the height direction and the width direction of a vehicle,

[Flow of Processing]

Next, a flow of detection size determination processing executed by the detection device 10 will be described. FIG. 8 is a flowchart illustrating a flow of detection size determination processing, The determination processing illustrated in FIG. 8 is processing of determining the upper limits and lower limits of respective sizes in the height and width directions for detecting a person and a vehicle, that is, the threshold values, as the detection sizes, on the basis of the size in the height direction of a person detected from the captured image.

First, as illustrated in FIG. 8, the captured image 200 captured by the camera device 100 is input to the detection device 10 (step S101). Here, the captured image 200 input in step S101 is a captured image captured by the camera device 100 of a person arranged at various positions to be monitored. Then, the captured image 200 is transmitted from the camera device 100, received by the detection device 10, and then input to the machine learning model generated on the basis of training data including the captured image 200 and the correct answer label indicating the target included in the captured image 200.

Next, the detection device 10 detects a person from the captured image 200 using the machine learning model (step S102). Note that it is possible that a plurality of persons is detected from one captured image 200,

Next, the detection device 10 acquires the size in the height direction of the person detected in step S102 (step S103). The size may be, for example, the number of pixels in the vertical direction of the rectangle surrounding the detected person.

Next, the detection device 10 compares the size acquired in step S103 with the minimum value and maximum value of the size in the height direction of a person stored in the detection size information 33 or the like, and updates the minimum value or maximum value if it can be updated (step S104).

Next, the detection device 10 determines whether a predetermined time has elapsed, for example, 1 minute, or the like, after starting the determination processing illustrated in FIG. 8, and returns to step S101 and repeats the processing using a new captured image 200 in the case where the predetermined time has not elapsed (step S105: No). Here, the new captured image 200 is, for example, the captured image 200 continuously captured by the camera device 100 even during execution of the determination processing illustrated in FIG. 8.

On the other hand, in the case where the predetermined time has elapsed (step S105: Yes), the detection device 10 determines the threshold values for the sizes in the height direction and the width direction of a person to be detected as the detection sizes of a person on the basis of the minimum value and maximum value of the size in the height direction of a person (step S106). Here, the threshold values for the sizes in the height direction and the width direction of a person are, for example, the lower limit 310 and the upper limit 410 of the detection size in the height direction of a person and the lower limit 320 and the upper limit 420 of the detection size in the width direction of a person described in FIGS. 4 and 5.

Next, the detection device 10 determines the threshold values for the sizes in the height direction and the width direction of a vehicle to be detected as the detection sizes of a vehicle on the basis of the minimum value and maximum value of the size in the height direction of a person (step S107). Here, the threshold values for the sizes in the height direction and the width direction of a vehicle are, for example, the lower limit 350 and the upper limit 450 of the detection size in the height direction of a vehicle and the lower limit 360 and the upper limit 460 of the detection size in the width direction of a vehicle described in FIGS. 6 and 7. After the execution of step S107, the determination processing illustrated in FIG. 8 ends.

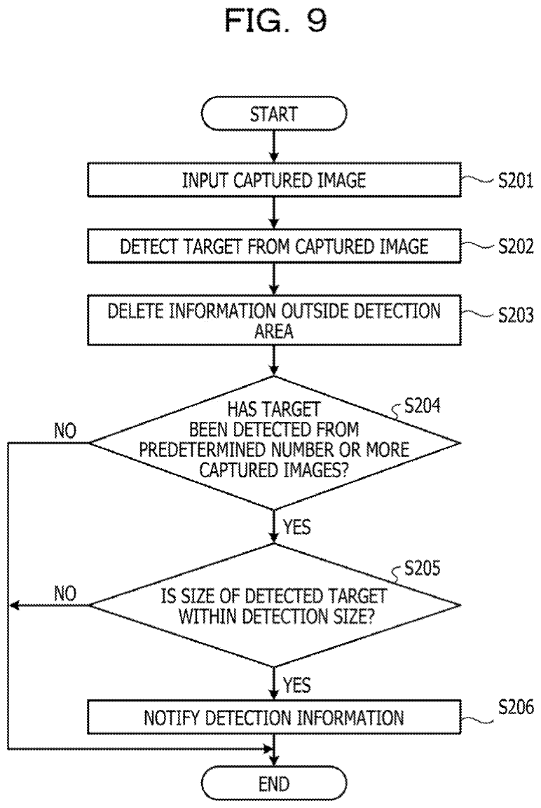

Next, a flow of the detection processing for a person or a vehicle executed by the detection device 10 will be described. FIG. 9 is a flowchart illustrating a flow of the detection processing. The detection processing illustrated in FIG. 9 is processing of detecting a person or a vehicle from the captured image 200 captured by the camera device 100, using the detection sizes determined by the determination processing illustrated in FIG. 8,

First, as illustrated in FIG. 9, the captured image 200 captured by the camera device 100 is input to the detection device 10 (step S201). Here, the captured image 200 input in step S201 is a captured image group captured by the camera device 100 and transmitted to the detection device 10 in real time.

Next, the detection device 10 detects the target from the captured image 200, using the machine learning model generated on the basis of the training data including the captured image 200 and the correct answer label indicating the target included in the captured image 200 (step S202). Note that the captured image 200 input in step S201 can be a captured image group, and there may be a plurality of captured images. In that case, the machine learning model is used for each of the captured images 200, and the target is detected. Furthermore, the target to be detected from the captured image 200 is only a person, only a vehicle, or a person and a vehicle designated according to the setting information 34. Therefore, the machine learning model may be used properly depending on the target to be detected. Note that it is possible that a plurality of targets is detected from one captured image 200.

Next, the detection device 10 deletes information outside the detection area on the basis of the range to be detected or the range not to be detected specified by the setting information 34 (step S203). This is because there are areas that do not need to be monitored in an unmanned facility or the like, so in the case where the target detected in step S202 is detected outside the detection area, the information is deleted and excluded from the detection target.

Next, in the case where the target is not detected from a predetermined number or more of the captured images 200 captured in succession (step S204: No), the detection processing illustrated in FIG. 9 ends Here, the predetermined number or more of the captured images 200 is, for example, three or more frames of the captured images out of ten frames of the captured images, but may be a smaller number or a larger number.

Meanwhile, in the case where the target is detected from a predetermined number or more of the captured images 200 captured in succession (step S204: Yes), the detection device 10 determines whether the sizes of the detected target fall within the detection sizes (step S205). More specifically, the detection device 10 determines whether the sizes in the height and width directions of the detected person respectively fall within the ranges from the lower limit 310 to the upper limit 410 in the height direction of a person, and from the lower limit 320 to the upper limit 420 in the width direction of a person, which are determined by the determination processing illustrated in FIG. 8. Similarly, in the case where the detected target is a vehicle, the detection device 10 determines whether the detected sizes fall within the ranges from the lower limit 350 to the upper limit 450 in the height direction of a vehicle, and from the lower limit 360 to the upper limit 460 in the width direction of a vehicle, which are determined by the determination processing illustrated in FIG. 8.

In the case where the sizes of the detected target do not fall within the detection sizes (step S205: No), the detection processing illustrated in FIG, 9 ends. On the other hand, in the case where the sizes of the detected target fall within the detection sizes (step S205: Yes), the detection device 10 notifies the surveillant of the detection of the person or the vehicle by turning on a light source, outputting a sound, transmitting an e-mail, or the like (step S206). After the execution of step S206, the detection processing illustrated in FIG. 9 ends.

[Effects]

As described above, the detection device 10 detects a person included in a plurality of first captured images captured by the camera device 100, determines the threshold value on the basis of the size in the height direction in the plurality of first captured images of the detected person, and detects the target from the first captured image captured by the camera device 100 on the basis of the threshold value.

Since the detection device 10 detects the target on the basis of the threshold value determined on the basis of the size in the height direction of the person actually detected from the captured image, the detection device 10 can perform control not to detect a rain mark on a road surface, or the like, that is erroneously detected as a small person, for example. Furthermore, by determining the threshold values of not only a person but also a vehicle on the basis of the size in the height direction of a person, the parameter settings can be more easily performed than the case of detecting both of a person and a vehicle and determining the threshold values from the respective sizes. Thereby, the detection device 10 can support surveillance using a video of the surveillance camera.

Furthermore, the processing of detecting the target, which is executed by the detection device 10, includes processing of detecting the target in the case where the target is detected from a predetermined number or more of captured images of a plurality of second captured images including the first captured images captured in succession on the basis of the threshold values.

Thereby, the detection device 10 can suppress erroneous detection of noise included in the captured image.

Furthermore, the threshold value includes a first threshold value in the height direction of the target and a second threshold value in the width direction of the target.

Thereby, since the detection device 10 can determine the threshold values of the detection target only by the size in the height direction of a person, the detection device 10 can easily perform the parameter settings than the case of determining the threshold values from the respective sizes in the height direction and the width direction of the detection target, for example.

Furthermore, the processing of determining the threshold values executed by the detection device 10 includes the processing of determining the threshold values on the basis of the minimum value and maximum value of the size in the height direction of the detected person.

Thereby, the detection device 10 can perform control so as not to detect, for example, a rain mark on a road surface, or the like, that is erroneously detected as a small person.

Furthermore, the detection device 10 further notifies the detection by at least one of turning on a light source, outputting a sound, or transmitting an e-mail in response to the detection.

Thereby, the detection device 10 can notify the surveillant or the like in the case of detecting the target, so the detection device 10 can support the surveillance using a video of the surveillance camera.

Furthermore, the detection target includes at least one of a person or a vehicle.

Thereby, the detection device 10 can divide the detection target according to a facility to be monitored or the like.

Furthermore, the detection is executed using the machine learning model generated on the basis of the training data including an image and the correct answer label indicating the target included in the image executed by the detection device 10.

Thereby, the detection device 10 can more efficiently and accurately detect a person from the captured image.

[System]

Pieces of information including a processing procedure, a control procedure, a specific name, various types of data, and parameters described above or illustrated in the drawings can be changed in any ways unless otherwise specified. Furthermore, the specific examples, distributions, numerical values, and the like described in the embodiments are merely examples, and can be changed in any ways.

Furthermore, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part thereof can be configured by being functionally or physically distributed or integrated in optional units according to various types of loads, usage situations, or the like. Moreover, all or any part of individual processing functions performed in each device may be implemented by a central processing unit (CPU) and a program analyzed and executed by the CPU, or may be implemented as hardware by wired logic.

[Hardware]

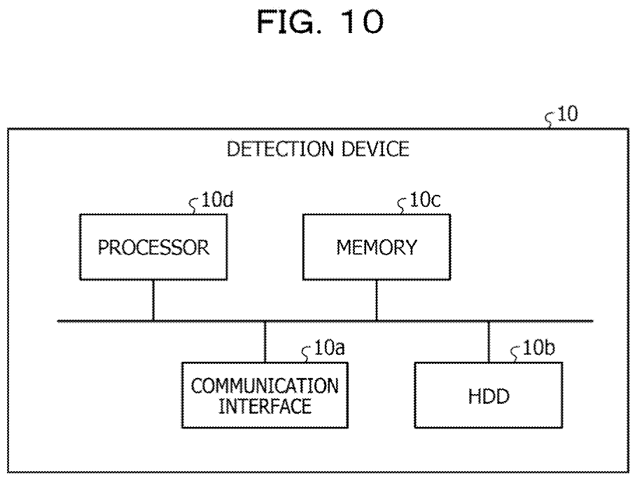

FIG. 10 is a diagram for describing a hardware configuration example. As illustrated in FIG. 10, the detection device 10 includes a communication interface 10a, a hard disk drive (HDD) 10b, a memory 10c, and a processor 10d. Furthermore, the units illustrated in FIG. 10 are mutually connected by a bus or the like.

The communication interface 10a is a network interface card or the like and communicates with another server. The HDD 10b stores programs and databases (DBs) for activating the functions illustrated in FIG. 2.

The processor 10d is a hardware circuit that reads a program that executes processing similar to the processing of each processing unit illustrated in FIG. 2 from the HDD 10b or the like, and develops the read program in the memory 10c, thereby activating a process that executes each function described with reference to FIG. 2 or the like. In other words, this process executes a function similar to the function of each processing unit included in the detection device 10. Specifically, the processor 10d reads a program having similar functions to the detecting unit 41, the determination unit 42, the detection unit 43, the notification unit 44, and the like from the HDD 10b or the like. Then, the processor 10d executes a process that executes similar processing to the detecting unit 41, the determination unit 42, the detection unit 43, the notification unit 44, and the like.

In this way, the detection device 10 operates as an information processing device that executes operation control processing by reading and executing the program that executes similar processing to each processing unit illustrated in FIG. 2. Furthermore, the detection device 10 can also implement functions similar to the above-described examples by reading the program from a recording medium by a medium reading device and executing the read program. Note that the program referred to in other examples is not limited to being executed by the detection device 10. For example, the present embodiment can be similarly applied to a case where another computer or server executes the program, or a case where these cooperatively execute the program.

Furthermore, a program that executes similar processing to each processing unit illustrated in FIG. 2 can be distributed via a network such as the Internet. Furthermore, this program can be recorded in a computer-readable recording medium such as a hard disk, flexible disk (FD), compact disc read only memory (CD-ROM), magneto-optical disk (MO), or digital versatile disc (DVD), and can be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a detection program for causing a computer to execute processing comprising:
detecting a person included in a plurality of first captured images captured by a camera;
determining a threshold value on the basis of a size in a height direction in the plurality of first captured images of the detected person; and
detecting a target from the first captured image captured by the camera on the basis of the threshold value.

2. The non-transitory computer-readable recording medium storing a detection program according to claim 1, wherein
the processing of detecting includes processing of detecting the target in a case where the target is detected from a predetermined number or more captured images of a plurality of second captured images that includes the first captured images captured in succession on the basis of the threshold value.

3. The non-transitory computer-readable recording medium storing a detection program according to claim 1, wherein
the threshold value includes a first threshold value in the height direction of the target and a second threshold value in a width direction of the target

4. The non-transitory computer-readable recording medium storing a detection program according to claim 1, wherein
the processing of determining includes processing of determining the threshold value on the basis of a minimum value and a maximum value of the size.

5. The non-transitory computer-readable recording medium storing a detection program according to claim 1, for causing the computer to further execute processing comprising:
notifying detection by at least one of turning on a light source, outputting a sound, or transmitting an e-mail in response to the detection.

6. The non-transitory computer-readable recording medium storing a detection program according to claim 1, wherein
the target includes at least one of a person or a vehicle.

7. The non-transitory computer-readable recording medium storing a detection program according to claim 1, wherein
the processing of detecting is executed using a machine learning model generated on the basis of training data that includes an image and a correct answer label that indicates the target included in the image.

8. A detection method comprising:
detecting, by a computer, a person included in a plurality of first captured images captured by a camera;
determining a threshold value on the basis of a size in a height direction in the plurality of first captured images of the detected person; and
detecting a target from the first captured image captured by the camera on the basis of the threshold value.

9. The detection method according to claim 8, wherein
the processing of detecting includes processing of detecting the target in a case where the target is detected from a predetermined number or more captured images of a plurality of second captured images that includes the first captured images captured in succession on the basis of the threshold value.

10. The detection method according to claim 8, wherein
the threshold value includes a first threshold value in the height direction of the target and a second threshold value in a width direction of the target

11. The detection method according to claim 8, wherein
the processing of determining includes processing of determining the threshold value on the basis of a minimum value and a maximum value of the size.

12. The detection method according to claim 8, for causing the computer to further execute processing comprising:
notifying detection by at least one of turning on a light source, outputting a sound, or transmitting an e-mail in response to the detection.

13. The detection method according to claim 8, wherein
the target includes at least one of a person or a vehicle.

14. The detection method according to claim 8, wherein
the processing of detecting is executed using a machine learning model generated on the basis of training data that includes an image and a correct answer label that indicates the target included in the image.

15. An information processing device comprising:
a memory; and
a processor coupled to the memory and configured to:
detect a person included in a plurality of first captured images captured by a camera;
determine a threshold value on the basis of a size in a height direction in the plurality of first captured images of the detected person; and
detect a target from the first captured image captured by the camera on the basis of the threshold value.

16. The information processing device according to claim 15, wherein
the processor detects the target in a case where the target is detected from a predetermined number or more captured images of a plurality of second captured images that includes the first captured images captured in succession on the basis of the threshold value.

17. The information processing device according to claim 15, wherein
the threshold value includes a first threshold value in the height direction of the target and a second threshold value in a width direction of the target.

18. The information processing device according to claim 15, wherein
the processor determines the threshold value on the basis of a minimum value and a maximum value of the size.

19. The information processing device according to claim 15, wherein
the processor notifies detection by at least one of turning on a light source, outputting a sound, or transmitting an e-mail in response to the detection.

20. The information processing device according to claim 15, wherein
the target includes at least one of a person or a vehicle.
